(19) United States
(12) Patent Application Publication
(10) Pub. No.: US 2025/0035520 A1
(43) Pub. Date: Jan. 30, 2025

(54) APPARATUS FOR MAGNETIC PURIFICATION OF BIOLOGICAL SAMPLES

(71) Applicants: Stefan SCHREIER, Walderbach (DE); SANOLIBIO CO., LTD., Samut Prakan (TH)

(72) Inventors: Stefan SCHREIER, Walderbach (DE); Ulrich LANG, Badung (ID)

(73) Assignee: SANOLIBIO CO., LTD., Samut Prakan (TH)

(21) Appl. No.: 18/699,116

(22) PCT Filed: Oct. 7, 2022
(86) PCT No.: PCT/EP2022/077963

§ 371 Date: Oct. 9, 2024

(30) Foreign Application Priority Data
Oct. 8, 2021 (DE) 20 2021 105 458.1

(51) Int. Cl. G01N 1/34

(52) U.S. Cl. CPC G01N 1/34

(57) ABSTRACT

An apparatus for magnetic processing of biological samples comprising at least one device for generating a static magnetic field gradient. The device has at least one permanent magnet, which is designed as a rod-shaped dipole magnet with an air gap. The device also has at least one holder for sample vessels, which comprises at least two sample vessel receptacles. The sample vessel receptacles are arranged in a different relative position with respect to the device for generating a static magnetic field gradient. The at least two sample vessel receptacles are arranged such that a first sample vessel receptacle is located close to the air gap of the dipole magnet, and a second sample vessel receptacle is located close to a side wall of the dipole magnet.

### CROSS-REFERENCE TO RELATED APPLICATIONS

The present application is a U.S. National Stage Application of International Application No. PCT/EP2022/077963 filed Oct. 7, 2022 and published on Apr. 13, 2023 as WO 2023/057632 A1, which claims benefit and priority of Germany Patent Application No. DE20 2021 105 458.1 filed Oct. 8, 2021, each of which is incorporated herein by reference in its entirety for any purpose whatsoever.

### TECHNICAL FIELD

The present disclosure relates to an apparatus for magnetic processing, in particular for magnetic purification, of biological samples, wherein the processing is based on specific interactions of non-magnetic biological material with magnetic particles.

### BACKGROUND

In the field of biological and medical research, purification of biological material from a heterogeneous particle suspension is required for various analytical methods. There is great interest in the enrichment of cells and individual cellular organisms including bacteria and viruses, but also cell fragments such as proteins, peptides or nucleic acids.

For the sake of simplicity, the term “cells” is used here in the broadest sense and stands for all multicellular and unicellular organisms, but also for cell fragments and viruses as well as for individual biomolecules such as proteins, peptides or nucleic acids.

A variety of labelling methods are available to improve the separation or to establish the separability of biological materials that are difficult or insufficient to separate, often based on so-called affinity reactions. The most common separation technology is based on the labelling of target cells or cell fragments with fluorescent dyes or synthetic magnetic particles. This magnetic cell separation technology is characterised by its simplicity and low cost compared to fluorescence-activated cell sorting.

Magnetic separation is performed by labelling target materials with receptor- or ligand-conjugated magnetic particles. The term “target material” refers to all substances and molecular structures that can combine with the biological material to form a specific binding pair.

The term “specific binding pair” refers to a pair or combination of substances that exhibit a binding tendency and includes elements such as cellular components, biospecific ligands and receptors. In this sense, the labelling of a target material is achieved by the association of specific binding pairs consisting of ligand and receptor. The term “ligand” refers to the component bound to the target material that is capable of specific binding and comprises antigens or haptens that are defined by at least one epitope or other characteristic determinants. The term “receptor” refers to the labelling target or a group thereof with biospecific affinity to an exclusive ligand. Possible receptors may be monoclonal antibodies or fragments thereof, specific binding proteins such as protein A or G, the biotin-streptavidin binding pair, aptamers, nucleic acids, etc. Preferably, the bio-specific binding is non-covalent, which requires high binding kinetics and possibly reversibility.

For a description of the prior art with regard to the production of magnetic particles suitable for magnetic cell separation technology, reference is made to patents U.S. Pat. Nos. 4,884,088, 4,654,267, 4,452,773 and 5,597,531. According to these documents, the particle core consists of magnetic materials such as magnetite, a ferromagnetic iron oxide. A crystal grain size of at least 30 nm is required to generate the so-called paramagnetic behaviour. Such magnetic materials are often referred to as magnetically sensitive, magnetisable or superparamagnetic, as they only exhibit high magnetic polarisation under the influence of an external magnetic field. This magnetic property prevents the aggregation of particles during and after the magnetic separation process due to insignificant residual magnetism. In addition, the composition of the magnetic particles partly determines the so-called enrichment efficiency. The magnetic particles have a maximum magnetic susceptibility, which is determined by the quantity and size of the ferromagnetic crystals in the core of the particle.

In general, magnetic separation technology can be divided into intrinsic and external processes. As already mentioned, magnetic particles smaller than 100 nm generate only very small magnetic moments in the presence of an external magnetic field source. However, the small particle size is associated with a favourable ratio between reactive surface and particle volume or particle quantity. Consequently, magnetic fractionation using so-called nanoparticles with diameters between 30 nm and 100 nm requires so-called high-gradient magnetic separation systems, which are described, for example, in patents U.S. Pat. Nos. 4,664,796, 5,200,084, WO 96/26782A and EP 0 942 766 A.

Commercially available intrinsic cell separation systems for general cell separation using magnetic nanoparticles with a diameter of 50 nm have been developed by Miltenyi AG. A so-called magnetic separation column is used, which consists of a ferromagnetic matrix in a non-magnetic container. For the purpose of magnetic separation, the separation column is placed in a strong external magnetic field. High magnetic field gradients of up to 100 Tesla/cm can be expected in the separation chamber. Compared to external magnetic separation methods, the process is complicated, prevents fast protocols, makes automation more difficult and increases costs. In addition, the magnetic separation matrix creates a large reactive surface that can exert stress on viable cells or increase the non-specific binding of cells to the reactive surface.

In order to avoid the disadvantages of magnetic separation columns and to utilise the advantages of using nanoparticles, external high-gradient magnetic separation systems have been developed. The focus was placed on external specialised magnet configurations, such as the quadrupole or hexapole configuration, as described for example in patent U.S. Pat. No. 5,186,827. Such magnets generate field gradients in the range of 1.5 Tesla/cm, but require larger magnetic particles with a size (diameter) in the range of 150 nm to 4 μm.

The use of magnetic particles with a diameter of more than 500 nm enables the use of a very simple and less costly magnetic separation, in which an incubation container is placed next to a simple permanent magnet. Commercially available systems are offered, for example, by Dynal Inc. under the name Dynal MPC1.

A similar system is described in the US patent application US 2010/0264090 A1. The apparatus described there is aimed at the most effective possible separation of already magnetised particles in a medium. The magnetic separation apparatus comprises at least one permanent magnet and a receiving apparatus for sample vessels, which is designed in particular in such a way that the sample vessels are located at the location of the greatest magnetic field gradient for effective separation. However, the strength of the magnetic field gradient varies over the height of the sample vessel, particularly in the case of larger sample vessels. Therefore, in certain embodiments of the apparatus described in US 2010/0264090 A1, it is provided that the sample vessels can be arranged in two different positions so that either the main volume of the sample vessel or the tip of the sample vessel is exposed to the strongest

magnetic field gradient (cf., for example, paragraph [0185] in this publication). As

can be seen in particular from paragraphs [0199] and ff. of US 2010/0264090 A1, this publication deals exclusively with the magnetic separation of already magnetisable particles. The actual incubation of biological material with magnetic particles takes place outside the apparatus described there. For this purpose, certain embodiments even provide for the sample receptacle to be detachable from the magnetic field unit (cf., for example, paragraphs [0199] ff.).

An important aspect, however, in the further development of separation systems based on magnetic particles is the improvement of the enrichment quality, which in essence means that the loss of the desired cells is reduced and their purity is maximised. The enrichment process usually consists of an incubation phase for magnetic labelling of the target material and subsequent magnetic separation. Typically, incubation is performed at rest if particles no larger than 150 nm are used, or with occasional mixing if larger particles with sedimentation tendencies are used.

Patent DE 10 2015 013 851 describes a magnetic labelling process in which particles are incubated with biological material in the presence of a magnetic field and with rotation of the incubation container. It was shown that the method results in a higher efficiency of magnetic labelling and produces a higher quantity of target-bound magnetic particles within shorter time intervals compared to incubation at rest. The term “dynamic magnetic labelling” was later introduced by Schreier et al. 2017 to describe an active form of magnetic labelling compared to the more passive incubation at rest: It was hypothesised that the rotation of the incubation container in the presence of the magnetic field forces and enhances the collision of the particles with the target material and thus accelerates the reaction kinetics. The term “collision behaviour” refers to forms of movement that are responsible for the generation of all types of bonds between a reaction pair of the same or different types. In general, collision behaviour can be characterised by the linear moment of a magnetic particle, the frequency or amount of collisions per time interval between two identical or two different reaction pairs, the sum of collisions over a certain incubation period of a reactant with other different reactants, and the duration of contact between a reaction pair.

Magnetic particles can be roughly categorised into nanoparticles and microparticles depending on their size. Magnetic nanoparticles (30 nm to 150 nm) are also known as ferrofluids due to their properties. Such particle suspensions form stable colloids, are subject to Brownian motion and do not sediment even over long periods of time (months to years). Nanoparticles are therefore very mobile in solution and form high reactive surfaces, thus promising more efficient magnetic labelling and deposition and faster reaction kinetics compared to microparticles (>0.2 μm), as mentioned for example in patent U.S. Pat. No. 5,541,072. The need for more efficient systems and thus the use of nano-sized particles is particularly evident in the magnetic deposition of rare cells (1 cell per mL), such as tumour cells or stem cells, in the peripheral blood circulation. Furthermore, the use of microparticles for magnetic labelling often requires subsequent separation of the particles from the target cells, as larger particles tend to clump together with the target substance and can therefore hinder subsequent examinations, such as fluorescence microscopy or flow cytometry. Previous methods for the subsequent separation of labelling material and innovations were described in detail in patent US 20150204857. The prior art described so far does not provide any contribution to improving the quality of enrichment.

In the applicant's international patent application WO 2020/161252 A1, an optimised and highly automated apparatus for the magnetic purification of biological samples is described, in which the relative position of a sample vessel with respect to a permanent magnet can be changed by means of a movable and rotatable sample receptacle, and also the rotational speed of the sample vessel can be changed in the course of successive process steps in order to vary the strength of the magnetic field acting on the sample, in particular the strength of the magnetic field gradient, as well as the mixing of the sample, during the process steps of sample addition, sample incubation, washing and subsequent separation. Such an apparatus is quite costly, so that ultimately only highly specialised laboratories can make such investments. Furthermore, the operation and programming of such an automated apparatus is complex, so that it is only suitable to a limited extent for the development of new protocols or assays for the magnetic processing of biological samples.

The present disclosure addresses the technical problem of realising the considerations described in WO 2020/161252 A1 for the efficient magnetic processing of biological samples, both with regard to the specific incubation with magnetic or magnetisable particles and with regard to separation, in a more cost-effective manner, i.e. to provide a more cost-effective apparatus for the magnetic processing of biological samples, which realises at least some of the advantages of the apparatus described in WO 2020/161252 A1. Magnetic processing should also be possible with smaller magnetic particles than those used in the simple cell separators of the prior art. Furthermore, the apparatus according to the disclosure is intended to enable simple and rapid handling, so that it can also be used in the development of new protocols or assays.

### SUMMARY

This technical problem is solved by the apparatus for magnetic processing, in particular for magnetic purification, of biological samples, having the features of the present claim 1. Advantageous developments of the present disclosure are the subject of the dependent claims.

The present disclosure is based on the observation that a very good specificity of the binding of magnetic particles to desired cells can already be achieved if at least the strength of the magnetic field gradient is varied in individual process steps, while mixing can also be realised by short mixing processes, for example with the aid of a vortex mixer, outside the magnetic field instead of by variable rotation.

Accordingly, the present disclosure relates to an apparatus for magnetic processing, in particular for magnetic purification, of biological samples, having at least one device for generating a static magnetic field gradient, at least one holder for sample vessels which comprises at least two sample vessel receptacles, said sample vessel receptacles being disposed in a different position relative to the device for generating a static magnetic field gradient. In the present context, a different relative position is understood to mean that the magnetic field generated by the device for generating a static magnetic field gradient differs in at least one parameter in the region of the at least two sample vessel receptacles. If, for example, the apparatus and in particular the device for generating a static magnetic field gradient exhibit certain symmetries, a symmetrical arrangement of the two sample vessel receptacles with respect to these symmetries would not be a “different relative position” in the sense of the present disclosure. Depending on the type of device used to generate a static magnetic field gradient and the size of the sample vessels used, a certain change in the parameters of the magnetic field may also result, in particular via the height of the sample vessels. The at least two sample vessel receptacles provided according to the disclosure should be located at such different locations with respect to the device for generating a static magnetic field gradient that a sample vessel inserted into the first sample vessel receptacle is not acted upon at any point of the sample located therein by a magnetic field which corresponds to the magnetic field acting on a sample located in a sample vessel inserted into the second sample vessel receptacle. In particular, the two sample vessel receptacles provided according to the disclosure are not configured in such a way that the same, preferably maximum magnetic field gradient acts at different points of the sample vessel, as is proposed, for example, in US 2010/0264090 A1.

Preferably, the at least two sample vessel receptacles are arranged with respect to the device for generating a static magnetic field gradient in such a way that the magnetic field differs in magnitude and/or gradient at the location of the sample vessels inserted into the sample vessel receptacles. In this way, sample vessels can be exposed to a magnetic field that is stronger or weaker and/or has a larger or smaller magnetic field gradient in different process steps.

For this purpose, it is advantageous if the sample vessels can be changed between the sample vessel receptacles, i.e. the sample vessel receptacles of the apparatus are preferably designed so that they can accommodate the same sample vessels.

Various physical techniques can be used to generate the magnetic field gradient. For example, the device for generating a magnetic field gradient can comprise at least one electromagnet. In this case, the apparatus preferably also comprises a power supply for the electromagnet, for example a built-in battery or an accumulator or even an electrical mains connection. Particularly preferably, the device for generating a magnetic field gradient comprises at least one permanent magnet, since in this case the apparatus according to the disclosure does not require any power supply and can be designed to be particularly cost-effective.

In a preferred embodiment, the permanent magnet is designed as a substantially bar-shaped dipole magnet with an air gap. Such an arrangement creates a particularly strong magnetic field gradient in the vicinity of the air gap.

In this case, the at least two sample vessel receptacles are preferably arranged in such a way that a first sample vessel receptacle is located close to the air gap of the dipole magnet, i.e. at a location with a high magnetic field gradient. The second sample vessel receptacle can then be arranged on a side face of the dipole magnet, for example in the centre of a full magnet portion of the dipole magnet. At the location of the second sample vessel receptacle, for example, there would then be a lower magnetic field gradient but, depending on the distance from the side face, possibly a higher absolute magnetic field than at the location of the first sample vessel receptacle. One of the sample vessel receptacles ensures that the sample vessels used there are at a location with a maximum magnetic field gradient. This sample vessel receptacle is used in particular for separating biological material that is already loaded with magnetic particles. The second, and possibly further, sample vessel receptacles are preferably located at locations with a lower magnetic field or lower magnetic field gradient and can accordingly be used for process steps, such as the addition of magnetic particles to the sample and in particular for incubating the sample with the added magnetic particles, in order to enable the most selective possible binding of the magnetic particles to the target material. According to one embodiment, the second sample vessel receptacle is arranged such that the magnetic field gradient is lower compared to the first position and, for example, a relatively homogeneous magnetic field is formed over the sample vessel, so that controlled kinetics of the magnetic particles can be generated in the sample vessel, which supports the specific binding. When adding magnetic particles to the sample, the magnetic field is selected in particular in such a way that although fractionation of the particles occurs, the particles can be easily resuspended again in the subsequent mixing step, which takes place outside the apparatus, in order to achieve a mixture of sample and magnetic particles that is as homogeneous as possible for the subsequent incubation.

Preferably, at least one third sample vessel receptacle is provided, which is arranged at a greater distance from the dipole magnet than the first and second sample vessel receptacles. Both a lower magnetic field and a lower magnetic field gradient are then present at the location of the third sample vessel receptacle. The third sample vessel receptacle can be used in particular for incubation.

It is understood that further sample vessel receptacles can be provided in the apparatus according to the disclosure. If more than three sample vessel receptacles are provided, the incubation step in particular can be modified. Depending on the position of the sample vessel receptacles, the magnetic or magnetisable particles used, the desired or undesired target material, the viscosity of the solution and other parameters, the controlled collision of the magnetic particles with the desired target material (in the case of a positive selection) or the undesired target material (in the case of a negative selection), for example, can be controlled and modified. This makes it possible, for example, to optimise the specific binding with regard to the speed of the particles and the attacking moments to which the magnetic particles are exposed on a surface of the biological material, such as a cell membrane. Alternatively, the enrichment efficiency can be optimised either in favour of the so-called deposition efficiency or in favour of the purity of the target material, depending on the type of selection (positive or negative), by using additional sample vessel receptacles.

Structurally, the apparatus according to the disclosure can be realised in different ways. In one embodiment, the apparatus according to the disclosure comprises a housing that encloses the device for generating a magnetic field gradient. The housing is preferably made of non-magnetic material, for example aluminium or a plastics material. The top of the housing then forms the holder for sample vessels and the sample vessel receptacles can be designed as openings on the top. The top of the housing can also be designed as a housing cover, which can be firmly connected to a housing base, for example glued, screwed, clipped or welded. The housing cover can also be removable so that the device for generating a magnetic field gradient can be easily accessed if required.

The openings on the top of the housing are preferably designed to receive reaction vessels, which can typically hold fluids in the order of micro- to millilitres. The reaction vessels are also typically made of non-magnetic materials, for example plastics materials, which are inert to the fluids used.

The top of the housing can have suitable labelling at the openings so that the user can easily assign each opening to the corresponding predefined protocol steps of a processing procedure.

In one embodiment of the disclosure, at least one of the openings for receiving the sample vessels is provided with a bevelled inner face, the contour of which is adapted to the outer periphery of the sample vessel. With a substantially flat top of the apparatus according to the disclosure, a typical opening has vertical inner faces, i.e. the inner face forms a substantially right angle with the top, so that the sample vessels are also inserted vertically into the apparatus. In contrast, a bevelled inner face means an inner face of the opening that forms an angle deviating from 90 degrees with the top of the housing cover, so that the sample vessel is inserted into the opening at a corresponding angle. Typical sample vessels used with the apparatus according to the disclosure have a cylindrical neck (usually with a sealable lid) and a conical tip. The sample fluid is typically located in the conical lower region of the sample vessel. By inserting the sample vessels at an angle, which is ensured by the bevelled inner face of the opening of the sample receptacle, the tip of the sample vessel can be positioned more optimally in the region of the maximum magnetic field gradient than would be possible with a vertical orientation of the sample vessel. Preferably, the bevelling of the inner face of the opening is adapted to the corresponding cone angle of the commonly used sample vessels with regard to the angle to the top of the apparatus, so that the surface of the cone of the sample vessel directed towards the gap of the dipole magnet is substantially vertically oriented. As a result, at least a large part of the sample fluid is located in the region of a homogeneous magnetic field gradient, and in particular, if the sample receptacle is the sample receptacle arranged directly at the gap of the dipole magnet, in the region of the maximum magnetic field gradient.

The at least one holder of the apparatus according to the disclosure can also comprise container receptacles for reaction fluid containers. These are preferably formed at locations of the apparatus where there is only a low magnetic field strength. For example, the container receptacles for reaction fluid containers can be formed as openings which are recessed on the outer periphery of the top of the housing of the apparatus.

The apparatus according to the disclosure also relates to a set for the magnetic purification of biological samples comprising an apparatus for the magnetic purification of biological samples of the type described above, as well as magnetic or magnetisable particles, in particular magnetic or magnetisable microbeads, as well as a protocol for the magnetic purification of biological samples oriented towards a specific purification problem. The magnetic or magnetisable particles/microbeads typically have a diameter in the range of from 100 to 500 nm.

### BRIEF DESCRIPTION OF THE DRAWINGS

The disclosure is explained in greater detail below with reference to an exemplary embodiment shown in the present drawings.

In the figures:

FIG. 1 shows a perspective view of an apparatus according to the disclosure for the magnetic purification of biological samples;

FIG. 2 shows the view of FIG. 1, with additional hidden lines being shown;

FIG. 3 shows a plan view of the apparatus of FIG. 1; and

FIG. 4 shows the view of FIG. 3, with additional hidden lines being shown.

### DETAILED DESCRIPTION

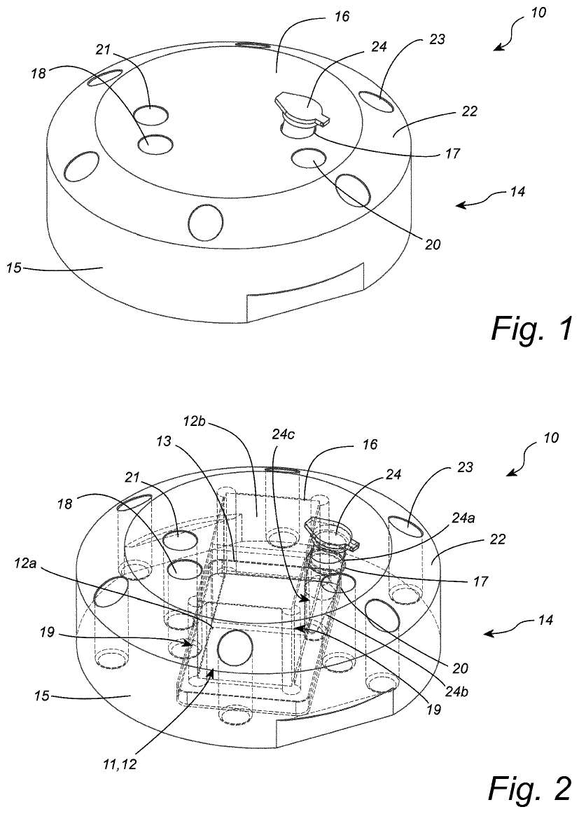

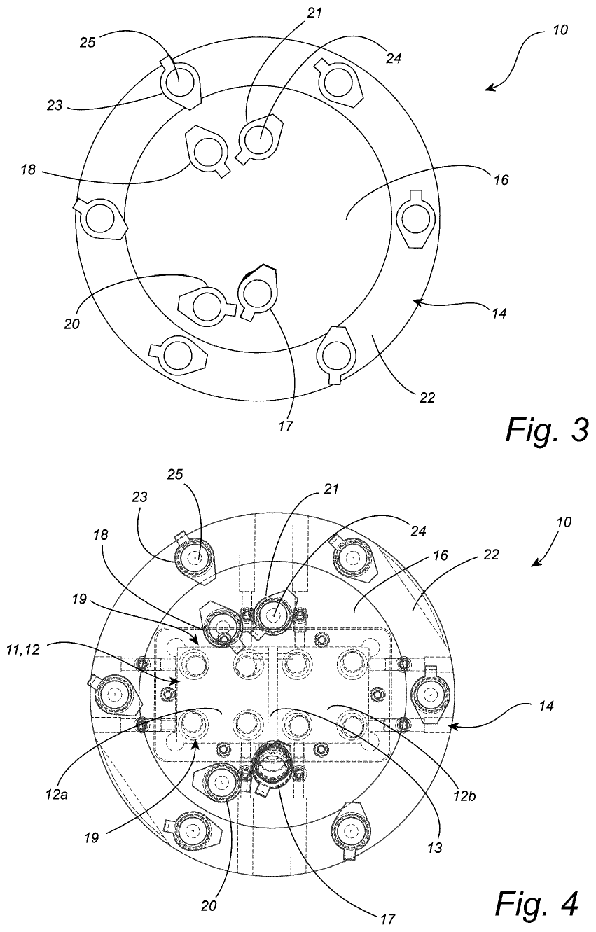

In FIGS. 1-4, the apparatus according to the disclosure for the magnetic processing, in particular purification, of biological samples is denoted on the whole by reference numeral 10. The apparatus 10 comprises a device for generating a static magnetic field gradient 11, which in the present example is designed as a permanent magnet, in particular as a substantially rod-shaped dipole magnet 12. The dipole magnet 12 has two solid magnet portions 12a, 12b, which are separated by an air gap 13. The highest magnetic field gradients occur in the outer region of the air gap 13. The rod-shaped dipole magnet 12 is arranged in a housing 14, which has a housing base 15 and a housing cover with a housing top 16. In the example shown, four sample vessel receptacles are recessed on the housing top 16 and are formed as openings on the top of the housing. As can be seen in particular from the plan view of FIGS. 3 and 4, a first sample vessel receptacle 17 is located directly on the outer region of the gap 13 of the dipole magnet 12. A second sample vessel receptacle 18 is located at the level of a side wall 19 of one of the full magnet portions 12a of the dipole magnet 12, i.e. in a region in which a lower magnetic field gradient prevails.

However, the magnetic field itself is comparatively high at the location of the second sample receptacle 18. A third sample vessel receptacle 20 is likewise arranged on a side wall 19 of the full magnet portion 12a, but at a greater distance than the second sample vessel receptacle 18, so that a lower magnetic field prevails at the location of the third sample vessel receptacle 20. In the example shown, a fourth sample vessel receptacle 21 is likewise shown, which is also located in the region of the gap 13 of the dipole magnet 12, but at a greater distance from the gap than the first sample vessel receptacle 17, so that both a lower magnetic field gradient and a lower absolute magnetic field prevail at the location of the fourth sample vessel receptacle 21 compared to the location of the first sample vessel receptacle. Further openings 23 for receiving reaction fluid containers are provided on the outer periphery 22 of the housing 14.

In the illustrations of FIGS. 1 and 2, for the sake of clarity, only a single sample vessel 24 is shown, which is inserted into one of the sample vessel receptacles, whereas FIGS. 3 and 4 show four sample vessels 24 and six reaction fluid containers 25 which are inserted into the corresponding vessel receptacles/openings. As can be seen in particular from FIG. 2, the sample vessel 24 inserted into the first sample receptacle 17 has a cylindrical neck 24a and a conically tapered tip 24b which is rounded at the bottom. The opening of the first sample receptacle 17 has a bevelled inner face, so that the sample vessel 24 is inserted into the first sample receptacle 17 at an angle and the conical region 24b of the sample vessel filled with sample fluid is located as close as possible to the air gap 13 of the dipole magnet 12. If, as shown, the bevelled inner face is adapted to the cone angle of the sample vessel with respect to its bevel angle, the sample vessel is inserted in such a way that a wall 24c of the conical portion 24b oriented towards the air gap 13 is oriented substantially vertically, so that a substantially homogeneous magnetic field gradient forms over this portion of the sample vessel.

### EXAMPLES

The use of the apparatus according to the disclosure described in FIGS. 1 to 4 is explained below using a simplified protocol for recovery of target blood cells using reactive magnetic anti-CD45 particles or anti-CD34 particles. In numerous assay protocols in which the apparatus according to the disclosure is used, the sample vessel is typically inserted into the first sample vessel receptacle 17 during washing steps and for final separation of the cell fraction associated with magnetic or magnetisable particles (maximum magnetic field gradient). The magnetic or magnetisable particles (microbeads) are typically added when the sample vessel is inserted into the fourth sample vessel receptacle 21. For incubation steps, the sample vessel is typically inserted into the second sample receptacle 18.

In the following examples, Example 1 uses a pre-purified cell fraction for the positive selection of rare haematopoietic stem cells. In Example 2, whole blood is used for the negative selection of very rare non-hematopoietic cells and requires two passes of magnetic processing with an intermediate lysis of the red blood cells.

### Example 1

### Materials:

incubation buffer solution: iso-osmolar phosphate-buffered solution, supplemented with 3% foetal bovine serum;
wash solution: iso-osmolar phosphate-buffered solution;
erythrocyte lysis buffer: 154 mM NH4Cl, 10 mM NaHCO3, 2 mM EDTA;
magnetic apparatus: aluminium-enclosed neodymium magnet type 2: 0.52 Tesla, two paired square dipole magnets in an arrangement of 30 mm×30 mm×30 mm per unit;
microcentrifuge 1.5 ml plastic container for incubation;
1 ml plastic syringe;
anti-CD34 kit consisting of superparamagnetic particles (microbeads), reactive against biotin and anti-CD34 antibodies conjugated with biotin (SanoLibio GmbH, Munich, Germany);
whole blood from healthy adult donors that has been stored in sodium heparin blood units for a maximum of 24 hours.

### Procedure:

Before enriching the leucocytes from whole blood, the erythrocytes were lysed with suitable lysis buffers (RBC lysis buffer), as known to a person skilled in the art, and the purified leucocytes were concentrated by centrifugation. The purified leucocytes were then incubated with the incubation buffer for 5 minutes at room temperature.

The further process steps were carried out manually or according to the new method and using the apparatus according to the disclosure. In all samples, anti-CD34-reactive antibodies were mixed with 3×10⁷ of processed leucocytes.

Step 1: Setting a specified cell suspension concentration and filling a sample vessel 24,

Step 2: Inserting the sample vessel 24 into the fourth sample vessel receptacle 21; adding magnetic microbeads,

Step 3: Short vortex mixing of the sample vessel 24 outside the

apparatus,

Step 4: Reinserting the sample vessel 24 into the second sample vessel receptacle 18 and magnetic incubation with the sample vessel closed: if necessary, intermediate vortex mixing outside the apparatus,

Step 5: Inserting the sample vessel 24 into the first sample vessel receptacle 17: washing the particle fraction by removing the supernatant and adding a washing solution (e.g. PBS) to the magnetic fraction in the magnetic field,

Step 6: Magnetic separation while the sample vessel remains in the first sample vessel receptacle 17. The desired cells are in the magnetic fraction.

### Example 2

The use of the apparatus according to the disclosure is explained below using a simplified protocol for the purification of non-hematopoietic target blood cells by means of negative selection directly from a whole blood sample using reactive magnetic anti-CD45 particles and process-integrated lysis of the red blood cells.

### Materials:

as described in Example 1, but using superparamagnetic particles reactive to CD45, conjugated with anti-CD45 antibodies (SanoLibio GmbH, Munich, Germany).

### Procedure:

A maximum of 1 mL of whole blood is directly incubated with the microbeads for manual depletion of the leukocytes or enrichment of rare cells from anti-coagulated fresh whole blood using the new method and the apparatus according to the disclosure, and the magnetised cells contained therein are then separated. Subsequently, the erythrocytes are lysed with suitable lysis buffers (RBC lysis buffer), as known to a person skilled in the art, and the purified cell suspension is concentrated by centrifugation. A second depletion step is carried out to achieve an acceptable enrichment efficiency.

Step 1: Placing the sample vessel 24 loaded with whole blood in the fourth sample vessel receptacle 21: adding magnetic microbeads,

Step 2: Short vortex mixing of the sample vessel 24 outside the apparatus,

Step 3: Reinserting the sample vessel 24 into the second sample vessel receptacle 18 and magnetic incubation with the sample vessel closed, if necessary, intermediate vortex mixing outside the apparatus,

Step 4: Inserting the sample vessel 24 into the first sample vessel receptacle 17; washing the particle fraction by removing or collecting the supernatant and adding a washing buffer (e.g. PBS) in the magnetic field (combine supernatants in a separate container),

Step 5: Magnetic separation of the collected supernatants while the new sample vessel is reinserted into the first sample vessel receptacle 17,

Step 6: Collecting the supernatant (step 5) and transferring to appropriate lysis buffer to lyse the red blood cells,

Step 7: Setting a specified cell suspension concentration by centrifugation and carrying out a second purification similarly to Example 1 (steps 1-4) and following steps 4 and 5 in this example. However. the desired cells in Example 2 are in the non-magnetic fraction.

1-14. (canceled)

15. An apparatus for magnetic processing of biological samples, comprising:
at least one device for generating a static magnetic field gradient, the device comprising at least one permanent magnet, which is designed as a rod-shaped dipole magnet with an air gap; and
at least one holder for sample vessels, which comprises at least two sample vessel receptacles;
wherein:
the sample vessel receptacles are arranged in a different relative position with respect to the device for generating a static magnetic field gradient, and
the at least two sample vessel receptacles are arranged such that a first sample vessel receptacle is located close to the air gap of the dipole magnet, and a second sample vessel receptacle is located close to a side wall of the dipole magnet.

16. The apparatus according to claim 15, wherein the at least two sample vessel receptacles are arranged with respect to the device for generating a static magnetic field gradient in such a way that the magnetic field differs in magnitude and/or gradient at the location of the sample vessels inserted into the sample vessel receptacles.

17. The apparatus according to claim 15, wherein the at least two sample vessel receptacles can receive the same sample vessels.

18. The apparatus according to claim 15, wherein at least one third sample vessel receptacle is provided, which is arranged at a greater distance from the dipole magnet than the first and second sample receptacles.

19. The apparatus according to claim 15, wherein the apparatus comprises a housing enclosing the device for generating a magnetic field gradient, the top of the housing forming the holder for sample vessels and the sample vessel receptacles being designed as openings in the housing top.

20. The apparatus according to claim 19, wherein at least one of the openings for receiving the sample vessels has bevelled inner faces.

21. The apparatus according to claim 20, wherein the at least two sample vessels define a cylindrical neck and a conical tip.

22. The apparatus according to claim 15, wherein the at least one holder additionally comprises container receptacles for reaction fluid containers.

23. A set for magnetic purification of biological samples, comprising:
an apparatus for the magnetic purification of biological samples according to claim 15;
magnetic or magnetisable particles, in particular microbeads; and
a protocol for the magnetic purification of biological samples.

24. A magnetic processing apparatus for purification of biological samples, the apparatus comprising:
a housing defining a base and a housing cover, a plurality of sample vessel receptacles recessed in the cover;
a rod-shaped dipole permanent magnet situated in the base of the housing, the rod-shaped dipole permanent magnet having two magnet portions separated by an air gap,
wherein:
a first sample vessel receptacle of the plurality of sample vessel receptacles is located in an outer region of the air gap,
a second sample vessel receptacle of the plurality of sample vessel receptacles is located proximate to a sidewall of a first of the magnet portions.

25. The magnetic processing apparatus of claim 24, wherein a third sample vessel receptacle of the plurality of sample vessel receptacles is located proximate to an opposite sidewall of the first magnet portion, further displaced from the first magnet portion than the second sample vessel receptacle.

26. The magnetic processing apparatus of claim 25, wherein a fourth sample vessel receptacle of the plurality of sample vessel receptacles is located in an opposite outer region of the air gap, further displaced from the air gap than the first sample vessel receptacle.

27. The magnetic processing apparatus of claim 24, wherein each sample vessel receptacle of the plurality of sample vessel receptacles defines a conically tapered tip with a rounded bottom and a cylindrical neck.

28. A magnetic processing apparatus comprising:
a housing defining an enclosure, a plurality of sample vessel receptacles recessed into the housing and enclosure;
a rod-shaped dipole permanent magnet situated in the enclosure, the rod-shaped dipole permanent magnet having two magnet portions separated by an air gap,
wherein:
a first sample vessel receptacle of the plurality of sample vessel receptacles is located proximate to the air gap along a major dimension of the air gap,
a second sample vessel receptacle of the plurality of sample vessel receptacles is located proximate to a sidewall of the rod-shaped dipole permanent magnet.

29. The magnetic processing apparatus of claim 28, wherein a third sample vessel receptacle of the plurality of sample vessel receptacles is located proximate to an opposite sidewall of the rod-shaped dipole permanent magnet, further displaced from the rod-shaped dipole permanent magnet than the second sample vessel receptacle.

30. The magnetic processing apparatus of claim 29, wherein a fourth sample vessel receptacle of the plurality of sample vessel receptacles is located proximate to the air gap along the major dimension of the air gap, further displaced from the air gap than the first sample vessel receptacle.

31. The magnetic processing apparatus of claim 28, wherein each sample vessel receptacle of the plurality of sample vessel receptacles defines a conically tapered tip with a rounded bottom and a cylindrical neck.

32. The magnetic processing apparatus of claim 28, wherein an opening of first sample vessel receptacle has a beveled inner face, such that a sample vessel inserted therein is angled towards the air gap.
